(19) United States
(12) Patent Application Publication
(10) Pub. No.: US 2023/0176566 A1
(43) Pub. Date: Jun. 8, 2023

(54) WIRELESS COMMUNICATION SYSTEM OF INTELLIGENT UAV

(71) Applicant: Coregleam Co.,Ltd., Daejeon (KR)

(72) Inventors: Hee Sung WOO, Daejeon (KR); Chang Hyoung RYU, Daejeon (KR); Jaeyong LEE, Daejeon (KR); Lae Seung JEONG, Daejeon (KR)

(21) Appl. No.: 17/597,393

(22) PCT Filed: Mar. 24, 2021
(86) PCT No.: PCT/KR2021/003662

§ 371 Date: Jan. 4, 2022

(30) Foreign Application Priority Data
Aug. 24, 2020 (KR) 10-2020-0106032

(51) Int. Cl. G05D 1/00; H04B 10/116; H04B 10/50; B64D 47/00; B64U 20/80; G05D 1/10

(52) U.S. Cl. CPC G05D 1/0022; B64D 47/00; B64U 20/80; G05D 1/101; H04B 10/116; H04B 10/502; B64U 2101/20; B64U 2201/20

(57) ABSTRACT

The present disclosure relates to a wireless communication system of an intelligent unmanned aerial vehicle (UAV), which may perform real-time communication between an intelligent UAV in air or in water and a ground control station by using visible light communication.

### CROSS REFERENCE TO RELATED APPLICATIONS

The present application is a U.S. National Phase of International Application No. PCT/KR2021/003662 entitled “WIRELESS COMMUNICATION SYSTEM OF INTELLIGENT UAV,” and filed on Mar. 24, 2021. International Application No. PCT/KR2021/003662 claims priority to Korean Patent Application No. 10-2020-0106032 filed on Aug. 24, 2020. The entire contents of each of the above-listed applications are hereby incorporated by reference for all purposes.

### TECHNICAL FIELD

The present invention relates to a wireless communication system of an intelligent unmanned aerial vehicle (UAV), and more particularly, to a wireless communication system of an intelligent UAV which may perform communication between the intelligent UAV and a ground control station by using visible light communication.

### BACKGROUND ART

An unmanned aerial vehicle (UAV, a drone for example) appeared in the early 2000′s and was developed as the unmanned aerial vehicle for military use. In its early days, the drone was used as a target for the Air Force’s missile bombing exercise, and gradually expanded its use as a reconnaissance plane or an attack plane.

Currently, the drone is being used not only for the military purposes, but also for personal, media and corporate purposes, and also it is being used in various industrial sites.

The name “drone” has been changed over time, and currently, the International Civil Aviation Organization (ICAO) considers the drone a remotely piloted aircraft system (RPAS). Literally translated, this name collectively refers to a “remote control system,” which is a system that may be operated in the air or in the water without a human on board by a remote or pre-entered navigation system.

An intelligent drone refers to a system in which the drone may not only rely on navigation coordinates simply entered or a remote control like a prior drone, but also determine a control situation itself and perform an additional operation other than mission performance entered in advance. For example, the drone may be equipped with an additional module such as any of various sensors and cameras, thereby recognizing an object by itself, determining the situation and avoiding an obstacle, or recording data.

In general, the drone may be controlled by using a radio control (RC) means within a visibility range, or the drone may be equipped with a terminal capable of performing long-term evolution (LTE) or wireless fidelity (wifi) wireless communication to be linked with a control system of a ground control station and remotely controlled by the same. The remote control system used for the intelligent drone may have a problem in its cost when using the LTE communication means, and a problem in that a flight range for the drone to perform its mission is limited when using the wifi communication means.

For example, when receiving a high definition (HD)-grade image data from the drone by using the LTE communication means, 1G or more of data may be used for one hour of use.

In addition, it may be difficult to stably use the LTE or wifi wireless communication in a wartime situation, bad weather conditions, a disaster situation or malicious radio jamming. Further, an underwater drone is unable to use a radio wave in the water unlike on the ground, and it is impossible for the drone and the ground control station to communicate with each other in the water. Therefore, the drone is required to be moved to the ground first to perform the communication with the ground control station.

In this regard, Korean Patent Publication No. 10-2004908 (entitled, “Underwater structure checking system of solar module apparatus by using underwater drone”), discloses an underwater drone which may perform communication with a control server by using an ultrasonic transceiver.

### RELATED ART DOCUMENT

### Patent Document

Korean Patent Publication No. 10-2004908 (published on Jul. 23, 2019)

### DISCLOSURE

### Technical Problem

The present invention has been made to solve the above-mentioned problems occurring in the prior art. An object of the present invention is to provide a wireless communication system of an intelligent unmanned aerial vehicle (UAV), which may perform real-time communication between an intelligent UAV in air or in water and a ground control station by using visible light communication.

### Technical Solution

In one general aspect, a wireless communication system of an intelligent unmanned aerial vehicle (UAV) includes: a flight control module 100 installed in the intelligent UAV, receiving detection information from sensors installed in advance in the UAV 10, and controlling the flight operation and flight posture of the UAV 10; a mission control module 200 installed in the UAV 10, generating mission flight data based on received data, transmitting the generated mission flight data to the flight control module 100 or transmitting either flight data collected while the UAV performs a mission flight or requested data; a first wireless communication module 300 installed in the UAV 10 and performing communication between the UAV 10 and a ground control station (GCS) 20; a control module 400 installed in the ground control station 20 and controlling a process of the mission flight of the UAV 10; and a second wireless communication module 500 installed in the ground control station 20 and performing the communication between the ground control station 20 and the UAV 10.

In addition, it may be preferable that the first wireless communication module 300 and the second wireless communication module 500 perform visible light communication (VLC).

In addition, it may be preferable that the first wireless communication module 300 includes a transmission means 310 for the visible light communication, and the transmission means 310 further includes a transceiver unit 311 connected to the mission control module 200 to receive the data, a data processing unit 312 sampling a transmission rate of the received data according to a preset communication rate and a light emitting diode (LED) switching unit 313 driving a LED-driving driver based on the sampled data to transmit the data by switching LEDs.

In addition, it may be preferable that the first wireless communication module 300 further includes a receiving means 320 for the visible light communication, and the receiving means 320 includes a receiver unit 321 receiving a switching data of the LED, a digital conversion unit 322 amplifying and processing the received switching data to convert the data into digital data, a data processing unit 323 verifying validity of the converted data, and processing the verified data to be transmitted to the mission control module 200 and a transceiver unit 324 transmitting the processed data to the mission control module 200.

In addition, it may be preferable that the second wireless communication module 500 includes a transmission means 510 for the visible light communication, and the transmission means 510 further includes a transceiver unit 511 connected to the control module 400 to receive the data, a data processing unit 512 sampling a transmission rate of the received data according to a preset communication rate and an LED switching unit 513 driving a LED driver based on the sampled data to transmit the data by switching LEDs.

In addition, it may be preferable that the second wireless communication module 500 further includes a receiving means 520 for the visible light communication, and the receiving means 520 includes a receiver unit 521 receiving a switching data of the LED, a digital conversion unit 522 amplifying and processing the received switching data to convert the data into digital data, a data processing unit 523 verifying validity of the converted data, and processing the verified data to be transmitted to the control module 400 and a transceiver unit 524 transmitting the processed data to the control module 400.

In addition, it may be preferable that the second wireless communication module 500 is installed in a docking station of the ground control station 20, to which the UAV 10 is coupled.

In addition, it may be preferable that the control module 400 is installed outside or inside the docking station, and is connected to the second wireless communication module 500 wirelessly or wired.

### Advantageous Effects

As set forth above, the wireless communication system of an intelligent UAV of the present invention may use the visible light communication to perform the real-time communication between the intelligent UAV and the ground control station in the air or in the water.

In addition, the wireless communication system of an intelligent UAV of the present invention may freely transmit and receive the data with the control system through the visible light communication in real time at the point where the UAV returns after accomplishing the mission flight in the air or in the water by using the wireless communication module (receiving module) installed at its landing point where the UAV returns after taking off.

### DESCRIPTION OF DRAWINGS

FIG. 1 is a schematic view showing visible light communication used in a wireless communication system of an intelligent unmanned aerial vehicle (UAV) according to an exemplary embodiment of the present invention.

FIG. 2 is an exemplary view showing a configuration of the wireless communication system of an intelligent UAV according to an exemplary embodiment of the present invention.

FIG. 3 is an exemplary view showing a detailed configuration of the wireless communication system of an intelligent UAV according to an exemplary embodiment of the present invention.

FIG. 4 is an exemplary view showing a transmission/reception communication protocol format of the wireless communication system of an intelligent UAV according to an exemplary embodiment of the present invention.

FIG. 5 is an exemplary view showing an operation of a transmission means of the wireless communication system of an intelligent UAV according to an exemplary embodiment of the present invention.

FIG. 6 is an exemplary view showing an operation of a reception means of the wireless communication system of an intelligent UAV according to an exemplary embodiment of the present invention.

### BEST MODE

Hereinafter, a wireless communication system of an intelligent unmanned aerial vehicle (UAV) of the present invention is described in detail with reference to the accompanying drawings. The accompanying drawings below are provided as examples for those skilled in the art to fully understand the spirit of the present invention. Therefore, the present invention is not limited to the accompanying drawings provided below, and may be implemented in another type. In addition, like reference numerals denote like elements throughout the specification.

Technical terms and scientific terms used in the present specification have the general meaning understood by those skilled in the art to which the present invention pertains unless otherwise defined, and a description for the known function and configuration unnecessarily obscuring the gist of the present invention is omitted in the following description and the accompanying drawings.

In addition, a system refers to a set of components including a device, a mechanism, a means and the like, systematized to perform a required function and regularly interacting with one another.

A wireless communication system of an intelligent UAV according to an exemplary embodiment of the present invention relates to a wireless communication system of an intelligent unmanned aerial vehicle (UAV), which may transmit data obtained from an UAV 10, which is an aerial or underwater drone, by using a wireless communication module mounted on the UAV 10 to a storage means by using a wireless communication module installed on the ground or underwater, while the UAV 10 is charged after taking off according to a control command by a ground control station 20, performing autonomous flight (mission flight) according to an entered navigation, obtaining flight data by taking a picture, performing terrain recognition or the like, and then returning to a pre-specified location (usually take-off point).

That is, the present invention relates to the wireless communication system of an intelligent UAV which may communicate data collected by visible light communication to the ground control station 20 in real-time while the UAV 10, which is equipped with the wireless communication module capable of performing the visible light communication, is wirelessly charged at its landing point after the UAV 10 accomplishes its mission flight based on an entered way-point input and then returns. Therefore, the UAV 10 may freely transmit and receive data with the control system through visible light wireless communication in real time at a point where the UAV 10 returns after accomplishing the mission flight in the air or in the water by using the wireless communication module (receiving module) installed at its landing point where the UAV 10 returns after taking off.

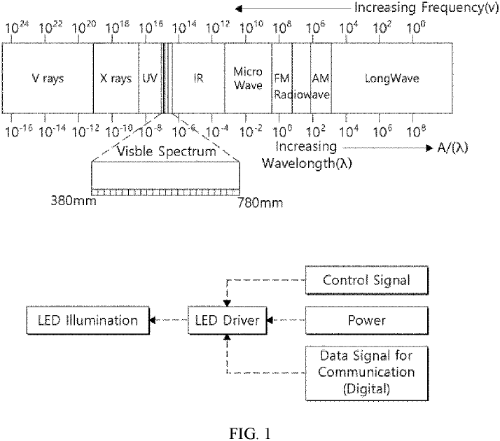

FIG. 1 is a schematic view showing data communication using lighting flicker, i.e. visible light communication, used in a wireless communication system of an intelligent unmanned aerial vehicle (UAV) according to an exemplary embodiment of the present invention. In detail, the visible light communication is technology in which a visible light band signal is used for short-distance wireless communication, and technology in which information is transmitted or exchanged using light used for lighting.

Even though using a wavelength most similar to a wavelength used in Infrared Data Association (IrDA), i.e. 800 to 900 nm, the visible light communication may have an advantage of simultaneously performing the communication and the lighting.

Therefore, an integrated control system of the intelligent UAV according to an exemplary embodiment of the present invention may request a current battery state of the drone, operation states and any abnormality of various sensors (posture control sensor, compass sensor, camera, gimbal, GPS and the like), and stored information on the mission flight (way-point, relative distance, mission assignment by using terrain or the like) from the ground control station by using the visible light communication while the aerial drone prepares for takeoff on the ground in case that the UAV is the aerial drone, or the underwater drone waits for its mission performance at an underwater docking station if the UAV is the underwater drone, for example.

The drone may return the information requested by the ground control station by using the visible light communication, and the ground control station may check and confirm the received information, prepare for the mission flight of the drone, and then instruct the drone to perform the mission.

The drone may then return to the landing point after accomplishing the mission flight, transmit information on the current battery state, flight log, data on the flight and the like to the ground control station by using the visible light communication again, and receive information on the flight, necessary for a next mission flight, from the ground control station, based on a result of the mission performance.

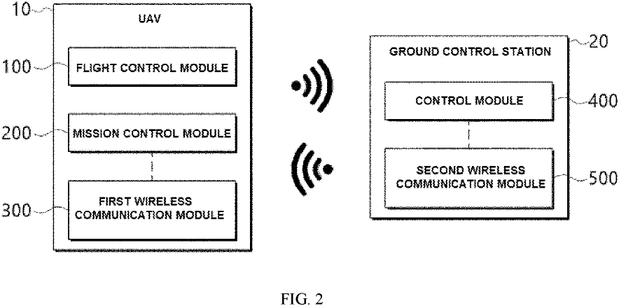

As shown in FIG. 2, the wireless communication system of an intelligent UAV according to an exemplary embodiment of this present invention may preferably include: a flight control module 100, a mission control module 200, and a first wireless communication module 300, installed in the UAV 10; and a control module 400 and a second wireless communication module 500, installed in the ground control station 20.

The respective components are described in detail.

The flight control module 100 is a flight control device module installed in the UAV 10, generally controlling a flight posture of the aerial or underwater drone, driving a propeller, and receiving flight control data (e.g. RC wireless data) to change the posture of the drone. As described above, the flight control module 100 may be installed in the intelligent UAV. Therefore, it may be preferable that the flight control module 100 receives detection information from sensors (e.g. inertial measurement unit (IMU) sensor and collision detection sensor) installed in advance in the UAV 10, and controls the flight operation and flight posture of the UAV 10.

Here, it may be preferable that the intelligent UAV receives flight route data for the mission flight in advance rather than the flight control data (e.g. RC wireless data) from the ground control station 20, and then controls the flight operation and flight posture of the UAV 10 by receiving the detection information from the sensors (e.g. IMU sensor and collision detection sensor) installed in advance in the UAV 10 through the flight control module 100.

The mission control module 200 is a mission computer module installed in the UAV 10, and may operate additional equipment such as a communication module which cannot be operated in the flight control module 100, analyze obtained camera image data in real time, or generate mission data through the communication with the ground control station 20. That is, it may be preferable that the mission control module 200 analyzes the data received from the ground control station 20 to generate mission flight data, and transmits the generated mission flight data to the flight control module 100 for the flight operation and flight posture of the UAV 10 to be controlled, converts flight data collected while the UAV performs the mission flight, that is, the obtained flight data to be transmitted to the ground control station 20, or converts requested data instructed by the ground control station 20 for the data to be transmitted to the ground control station 20.

It may be preferable that the first wireless communication module 300 is installed on the UAV 10, and in detail, is linked with the mission control module 200 and installed on the UAV 10, thereby performing the communication between the UAV 10 and the ground control station 20 in real time. It may be preferable that the first wireless communication module 300 performs the visible light communication as described above.

The mission control module 200 and the first wireless communication module 300 may be connected to each other by a serial interface or Ethernet. When receiving the data serially through the protocol receiving software (SW), the serial interface may put the data in a physical transmit queue (TX queue) and then deliver the same immediately. The Ethernet may enable the communication between the two modules by using a pre-stored internet protocol (IP) setting.

The control module 400 is a control software installed in the ground control station 20, and it may be preferable that the control module 400 performs various control operations, such as controlling a process of the mission flight of the UAV 10, in detail, transmitting the flight route data for the mission flight, receiving the flight data obtained from the UAV 10, analyzing the received data and transmitting additional flight route data, or requesting information on the state of the UAV 10, receiving the information and analyzing the mission flight that the UAV 10 may perform. In addition, the control module 400 may perform an operation of a recording storage device.

It may be preferable that the second wireless communication module 500 is installed in the ground control station 20 and performs the communication between the ground control station 20 and the UAV 10. It may be preferable that the second wireless communication module 500 performs the visible light communication like the first wireless communication module 300.

In addition, the flight control module 100, the mission control module 200 and the first wireless communication module 300 may all be installed in the UAV 10, and it is thus generally preferable that all the modules are included in a housing referred to as the UAV 10.

However, in some cases, the control module 400 and the second wireless communication module 500 may be connected to each other wirelessly or wired, and located far apart from each other.

For example, if the UAV 10 is the underwater drone, the second wireless communication module 500 may be installed in a docking station located in the water, and if the UAV 10 is the aerial drone, the second wireless communication module 500 may be installed in a docking station located at the landing point of the UAV 10. However, the control module 400 may here be located far apart from the second wireless communication module 500.

In particular, if the UAV is the underwater drone, the second wireless communication module 500 may be installed in the docking station located in the water. However, the control module 400 may be connected to the second wireless communication module 500 in real time through the Ethernet or the serial interface, which is provided in advance in the docking station, and may thus perform the communication between the UAV 10 and the ground control station 20 in real time.

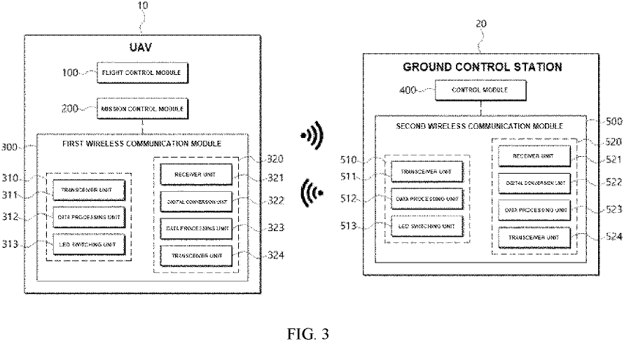

As shown in FIG. 3, it may be preferable that the first wireless communication module 300 and the second wireless communication module 500 include transmission means 310 and 510 and receiving means 320 and 520, respectively, because the UAV 10 and the ground control station 20 are required to perform two-way communication rather than one-way communication.

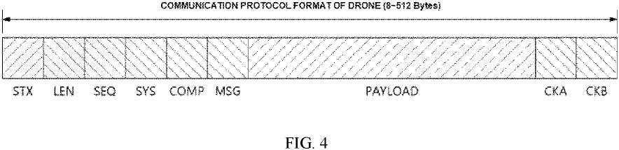

FIG. 4 is an exemplary view showing a communication protocol format transmitted/received between the intelligent UAV 10 and the ground control station 20. In general, a format used for device-to-device transmission may include start of text (STX) indicating start of a protocol, payload data including header information, actual control commands and response contents, and checksum data used for checking integrity of the protocol.

It is also possible to efficiently improve data transmission speed by minimizing an amount of data by implementing the communication based on the payload data of the protocol excluding the header data.

First, the description focuses on the first wireless communication module 300.

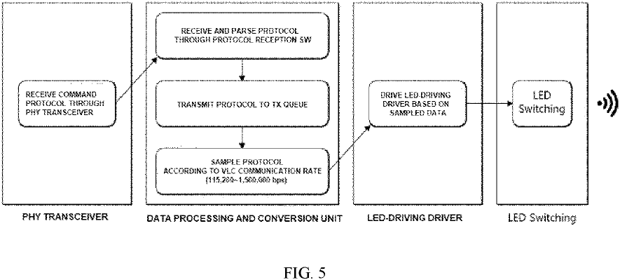

The transmission means 310 is a means for the visible light communication, and may preferably include a transceiver unit 311, a data processing unit 312 and an LED switching unit 313 as shown in FIG. 5.

It may be preferable that the transceiver unit 311 includes a physical layer protocol (PHY) transceiver, and is connected to the mission control module 200 to receive the data included in a physical receive queue (RX queue) from the mission control module 200.

The data processing unit 312 may preferably sample a transmission rate of the received data according to a preset communication rate. In detail, in the case of visible light communication, the transmission rate of the received data may be sampled to ensure stable data transmission and due to a limit in a speed at which light emitting diodes (LEDs) are physically switched to each other. For example, when a transmission rate of the visible light communication is 115,200 to 1,500,000 bps, a maximum data transmission rate may be physically implemented up to a speed provided by Ethernet depending on a speed of an LED-driving driver and a switching speed of the LED.

The LED switching unit 313 may preferably drive the LED-driving driver based on the sampled data to transmit the data to be transmitted from the mission control module 200 to the ground control station 20 by switching the LEDs.

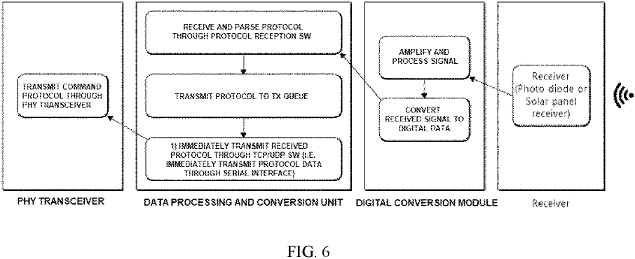

A receiving means 320 of the first wireless communication module 300 is a means for visible light communication. As shown in FIG. 6, the receiving means 320 may preferably include a receiver unit 321, a digital conversion unit 322, a data processing unit 323 and a transceiver unit 324.

The receiver unit 321 may generally include a photo diode, and may also include a solar panel. The receiver unit 321 may preferably receive a switching signal of the LED.

The digital conversion unit 322 may preferably amplify and process the received switching signal to convert the signal into digital data.

The data processing unit 323 may preferably verify validity of the converted data by using protocol reception software (SW), and process the verified data to be transmitted to the mission control module 200. In detail, it may be preferable that the verified data is transmitted to the TX Queue, protocol data included in the TX Queue is processed and then transmitted to the transceiver unit 324, and the data is transmitted through the serial interface or the Ethernet, connected to the mission control module 200.

Hereinafter, the description focuses on the second wireless communication module 500.

Even though operated in the same manner as the transmission means 310 and the receiving means 320 of the first wireless communication module 300, the second wireless communication module 500 may preferably be connected to the control module 400.

The transmission means 510 is the means for the visible light communication, and may preferably include a transceiver unit 511, a data processing unit 512 and an LED switching unit 513 as shown in FIG. 5.

It may be preferable that the transceiver unit 511 includes the physical layer protocol (PHY) transceiver, and is connected to the control module 400 to receive the data included in the RX Queue from the control module 400.

The data processing unit 512 may preferably sample the transmission rate of the received data according to the preset communication rate. In detail, in the case of visible light communication, the transmission rate of the received data may be sampled to ensure the stable data transmission and due to the limit in the speed at which the light emitting diodes (LEDs) are physically switched to each other. For example, when the transmission rate of the visible light communication is 115,200 to 1,500,000 bps, the maximum data transmission rate may be physically implemented up to the speed provided by Ethernet depending on the speed of the LED-driving driver and the switching speed of the LED.

The LED switching unit 513 may preferably drive the LED-driving driver based on the sampled data to transmit data to be transmitted from the control module 400 to the UAV 10 by switching the LEDs.

A receiving means 520 of the second wireless communication module 500 is the means for the visible light communication. As shown in FIG. 6, the receiving means 520 may preferably include a receiver unit 521, a digital conversion unit 522, a data processing unit 523 and a transceiver unit 524.

The receiver unit 521 may generally include the photo diode, and may also include the solar panel. The receiver unit 521 may preferably receive the switching signal of the LED.

The digital conversion unit 522 may preferably amplify and process the received switching signal to convert the signal into the digital data.

The data processing unit 523 may preferably verify the validity of the converted data by using the protocol reception software (SW), and process the verified data to be transmitted to the control module 400. In detail, it may be preferable that the verified data is transmitted to the TX Queue, the protocol data included in the TX Queue is processed and then transmitted to the transceiver unit 524, and the data is transmitted to the control module 400.

The integrated control system of an intelligent UAV according to an exemplary embodiment of the present invention is most suitable for a radio telemetry system in which the UAV is used by a remote control, the UAV not including the LTE communication device or the like, or the underwater drone which may not use the wireless communication. However, the present invention is not limited thereto.

However, when performing the remote control using short-distance and long-distance communication means such as the radio telemetry system and the LTE, a ground drone may be highly likely to experience communication loss, such as radio interference and the LTE communication impossible. In addition, the underwater drone (other than special military equipment such as a submarine) may not perform the real-time communication. Meanwhile, the integrated control system of an intelligent UAV according to an exemplary embodiment of the present invention may perform an autonomous flight and be under the remote control in any environment.

Hereinabove, although the present invention has been described by specific matters such as the detailed components, the exemplary embodiments and the accompanying drawings, they have been provided only for assisting in comprehensive understanding of the present invention. Therefore, the present invention is not limited to the exemplary embodiments, and various modifications and changes may be made by those skilled in the art to which the present invention pertains from this description.

Therefore, the spirit of the present invention should not be limited to the above-described exemplary embodiments, and the claims and all modifications equal or equivalent to the claims are intended to fall within the scope and spirit of the present invention.

Description of Reference Numerals

| | |
|---|---|
| 10: unmanned aerial vehicle | |
| 100: flight control module | |
| 200: mission control module | |
| 300: first wireless communication module | |
| 310: transmission means | |
| 311: transceiver unit | 312: data processing unit |
| 313: LED SWITCHING UNIT | |
| 320: receiving means | |
| 321: receiver unit | 322: digital conversion unit |
| 323: data processing unit | 324: transceiver unit |
| 400: control module | |
| 500: second wireless communication module | |
| 510: transmission means | |
| 511: transceiver unit | 512: data processing unit |
| 312: LED SWITCHING UNIT | |
| 520: receiving means | |
| 521: receiver unit | 522: digital conversion unit |
| 523: data processing unit | 524: transceiver unit |

1. A wireless communication system of an intelligent unmanned aerial vehicle (UAV), the system comprising:
a flight control module installed in the intelligent UAV, receiving detection information from sensors installed in advance in the UAV, and controlling the flight operation and flight posture of the UAV;
a mission control module installed in the UAV, generating mission flight data based on received data, transmitting the generated mission flight data to the flight control module or transmitting either flight data collected while the UAV performs a mission flight or requested data;
a first wireless communication module installed in the UAV and performing communication between the UAV and a ground control station (GCS);
a control module installed in the ground control station and controlling a process of the mission flight of the UAV; and
a second wireless communication module installed in the ground control station and performing the communication between the ground control station and the UAV.

2. The system of claim 1, wherein
the first wireless communication module and the second wireless communication module perform
visible light communication (VLC).

3. The system of claim 2, wherein
the first wireless communication module includes
a transmission means for the visible light communication, and
the transmission means includes
a transceiver unit connected to the mission control module to receive the data;
a data processing unit sampling a transmission rate of the received data according to a preset communication rate; and
a light emitting diode (LED) switching unit driving an LED driver based on the sampled data to transmit the data by switching LEDs.

4. The system of claim 2, wherein
the first wireless communication module includes
a receiving means for the visible light communication, and
the receiving means includes
a receiver unit receiving a switching data of the LED;
a digital conversion unit amplifying and processing the received switching data to convert the data into digital data;
a data processing unit verifying validity of the converted data, and processing the verified data to be transmitted to the mission control module; and
a transceiver unit transmitting the processed data to the mission control module.

5. The system of claim 2, wherein
the second wireless communication module includes
a transmission means for the visible light communication, and
the transmission means includes
a transceiver unit connected to the control module to receive the data;
a data processing unit sampling a transmission rate of the received data according to a preset communication rate; and
an LED switching unit driving an LED driver based on the sampled data to transmit the data by switching LEDs.

6. The system of claim 2, wherein
the second wireless communication module includes
a receiving means for the visible light communication, and
the receiving means 520 includes
a receiver unit receiving a switching data of the LED;
a digital conversion unit amplifying and processing the received switching data to convert the data into digital data;
a data processing unit verifying validity of the converted data, and processing the verified data to be transmitted to the control module; and
a transceiver unit transmitting the processed data to the control module.

7. The system of claim 2, wherein
the second wireless communication module is installed
in a docking station of the ground control station, to which the UAV is coupled.

8. The system of claim 6, wherein
the control module is installed
outside or inside the docking station, and is connected to the second wireless communication module wirelessly or wired.
